(19) United States
(12) Patent Application Publication
(10) Pub. No.: US 2023/0359321 A1
(43) Pub. Date: Nov. 9, 2023

(54) SYSTEM TO FACILITATE PURCHASING

(71) Applicant: Evrdrive, Inc., Houston, TX (US)

(72) Inventor: Cole Kutschinski, Tomball, TX (US)

(73) Assignee: Evrdrive, Inc., Houston, TX (US)

(21) Appl. No.: 17/661,867

(22) Filed: May 3, 2022

(51) Int. Cl. G06F 3/04815; G02B 27/14; G06F 3/0354; G06Q 30/06

(52) U.S. Cl. CPC G06F 3/04815; G02B 27/144; G06F 3/03543; G06Q 30/0643

(57) ABSTRACT

A method of providing a user with realistic images of a particular vehicle for sale utilizes a photomontage of the desired views of a particular vehicle. The photomontage is then projected utilizing a peppers ghost imaging system. Further, the user may manipulate the photomontage using for example a mouse or haptic sensors. During the user's session as each vehicle is displayed by the projection system a price is provided for the particular vehicle displayed.

### BACKGROUND

Currently, there is a shortage in logistical resources. The current shortage affects the supply chain such that it is difficult or at least expensive to move objects or resources from one point to another. It is further difficult to maintain supplies of similar resources in various locations.

For instance, automobile dealers are experiencing difficulties in maintaining inventory. In particular, it is difficult to maintain multiple copies of the same make and model of a vehicle at multiple locations. In some instances, the locations may be at various sites around a city or perhaps around a state or region or even an entire country.

Automobile dealers are currently attempting to find ways to keep a varied inventory of automobiles or vehicles at various locations while allowing potential customers access to each of those vehicles at the customer's location which may not be the same location as the vehicle. In some instances, the vehicles may be in a single location with the customers scattered across a region or country.

### SUMMARY

The following is an embodiment of the present invention. A 3D presentation allows a customer to view multiple vehicles at a single site. Generally, multiple images of a vehicle are gathered and arranged such that a portion of the images may be viewed together as a single projection. Preferably, the single projection is essentially life-size and is provided such that a person viewing the image may walk up to the image to view particular features as well as move around the image to view other features of the vehicle where the other features come into view as the person moves around the image.

For instance, a life-size image of a vehicle may be presented where the viewer of the image, a person, begins at the front of the vehicle looking at for example, a front fender. As the person's interest changes, the person may walk from the front fender to the front door, or perhaps the person walks from the front fender to the back of the car and, as the person walks around the back of the car, the arrangement of images provides a projection of the rear of the car. Alternatively, the person may decide that they want to look underneath the car and so the person may move their viewpoint down until the person is able to view the underside of the car in which instance such an arrangement of images provides a projection of the underside of the car.

In some instances, the person may remain stationary while the projection is moved past the person, as the person desires, to view particular features in the projection. For instance, the person may remain stationary while using an interactive device such as most session sensing gloves, a mouse, or other motion sensing devices to allow the person to move the image past the person as desired.

In some instances, it may be desirable to project reduced size projections of the life-size vehicle while projecting a life-size projection of a portion of the vehicle the person particularly desires to view. For instance, a holistic projection of the entire vehicle may be projected at one quarter scale while, at the same time, the viewer desires to view an enhanced, life-size, or even larger projection of a particular portion of the vehicle, such as the door, allowing the viewer to observe certain specific vehicle features or giving the viewer the chance to look for any defects or imperfections in the vehicle.

A 3D photomontage of a vehicle is created using multiple images. The photomontage may then be displayed utilizing a peppers ghost image projection in order to provide a realistic projection of the vehicle or multiple aspects of the vehicle on a single display. A projector linked to a computer may be utilized to manipulate the image as desired by the viewer.

### BRIEF DESCRIPTION OF THE DRAWINGS

FIG. 1 is a flowchart describing the steps to provide a photomontage with an imaging system to present full scale images of a particular vehicle to a buyer.

FIG. 2 is an orthographic projection of a peppers ghost projection system.

FIG. 3 is a side view of the peppers ghost projection system from FIG. 2.

FIG. 4 is an orthographic projection of an alternative arrangement of a peppers ghost projection system.

FIG. 5 is a side view of the peppers ghost projection system from FIG. 4.

FIG. 6 is a flowchart describing the steps to provide a purchasing system utilizing a peppers ghost type imaging system.

### DETAILED DESCRIPTION

The description that follows includes exemplary apparatus, methods, techniques, or instruction sequences that embody techniques of the inventive subject matter. However, it is understood that the described embodiments may be practiced without these specific details.

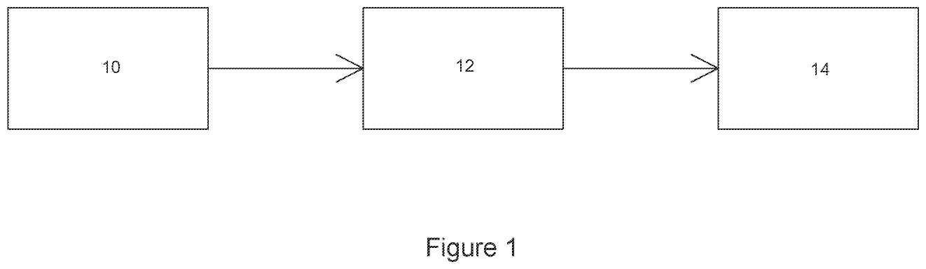

FIG. 1 is a flowchart describing the steps to provide a photomontage for an imaging system to present full scale images of a particular vehicle to a buyer. The system can then be used to present many particular vehicles in sequence or any particular parts of such vehicles to the buyer. Initially, shown in box 10, the particular vehicle that will be offered is put on display for imaging. As provided in box 12, multiple images are then taken of the displayed vehicle. Each image of the vehicle varies slightly in perspective and may be offset a few degrees from the previous image from side to side and/or up and down such that images of the entire vehicle are captured. Each image of the vehicle overlaps with an adjacent image by some amount. As provided in box 14, each of the images are arranged such that two or more images create a stitched image representing the entire particular vehicle or any desired portions or features of the particular vehicle. In some instances, the stitched image may be of the exterior of the vehicle while other stitched images may be various features of the vehicle such as the interior, the engine compartment, the trunk space, or other views of the vehicle.

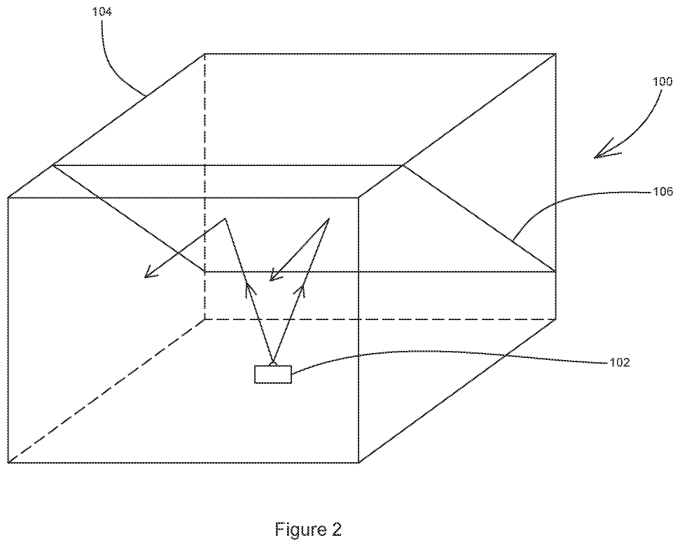

FIG. 2 is an orthographic projection of a peppers ghost projection system 100. In order to display the stitched image, it is envisioned that a virtual image will be created utilizing the peppers ghost type imaging system 100. The peppers ghost type imaging system 100 includes a projector 102, a frame 104, and an at least partially transparent screen 106. The frame 104 keeps the partially transparent screen 106 under tension and is inclined at an angle α with respect to a plane of transmission of light from the projector 102. The partially transparent screen 106 has a front surface arranged such that light emitted from the projector 102 is reflected off of the partially transparent screen 106. The projector 102 is arranged to project an image such that light forming the image impinges upon the partially transparent screen 106 such that a virtual image is created from light reflected from the partially transparent screen 106. The virtual image then appears to be located behind the partially transparent screen 106. While the partially transparent screen 106 is at least partially transparent it is also partially reflective at least upon the front surface.

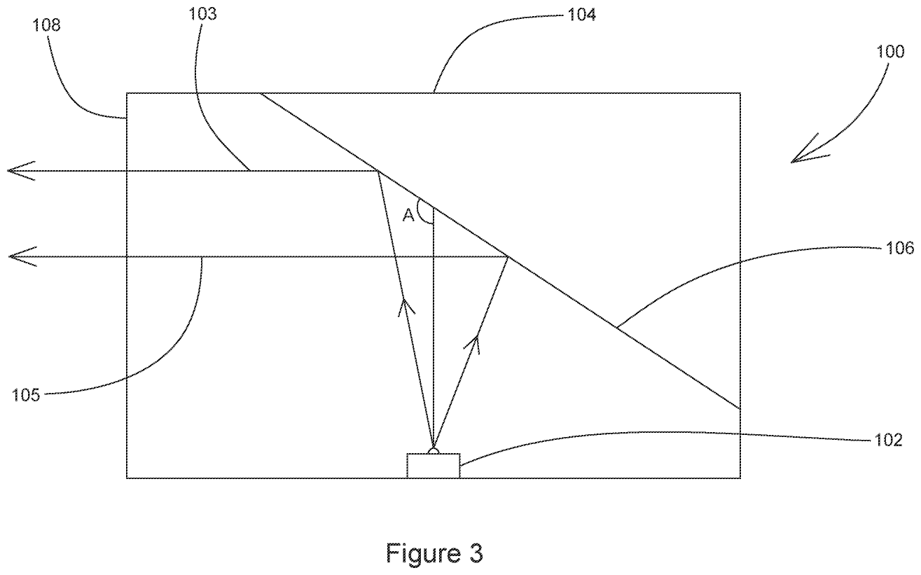

FIG. 3 is a side view of the peppers ghost projection system 100 from FIG. 2. The imaging system 100 includes projector 102, the frame 104, and the partially transparent screen 106. The peppers ghost type imaging system 100 has a front 108. The projector 102 is shown to be located near the bottom of the frame 104 and projects the light upwardly at some angle A with the partially transparent screen 106 such that the virtual image is created from light reflected, arrows 103 and 105, from the partially transparent screen 106.

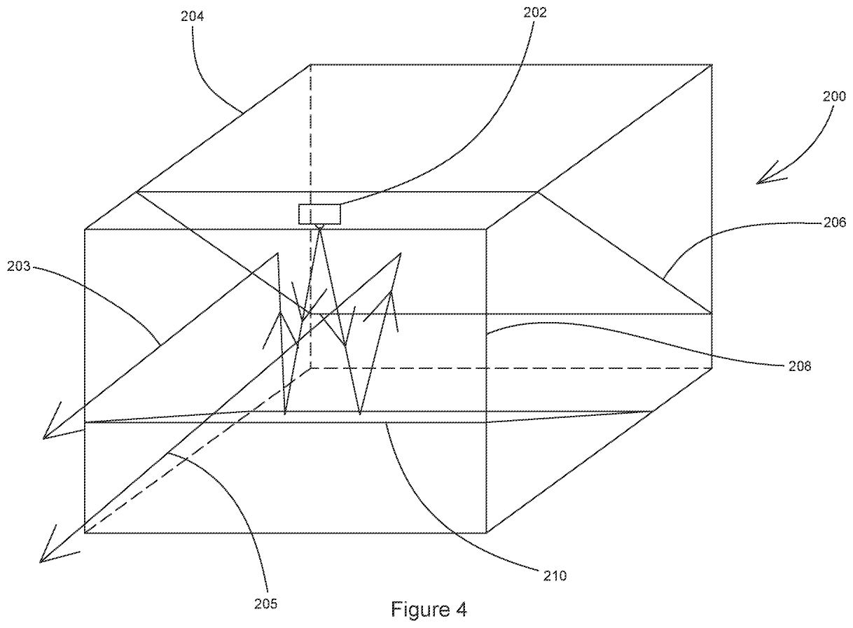

FIG. 4 is an orthographic projection of an alternative arrangement of a peppers ghost projection system 200. The peppers ghost type imaging system 200 includes a projector 202, a frame 204, an at least partially transparent screen 206, and a reflective screen 210. The frame 204 keeps the partially transparent screen 206 under tension and is inclined at an angle B with respect to a plane of transmission of light from the reflective screen 210. The partially transparent screen 206 has a front surface arranged such that light from the reflective screen 210 is reflected off of the partially transparent screen 206. The projector 202 is arranged to project an image such that light forming the image impinges upon the reflective screen 210 and is reflected towards the partially transparent screen 206 such that a virtual image is created from light reflected from the partially transparent screen 206. The virtual image then appears to be located behind the partially transparent screen 206. While the partially transparent screen 206 is at least partially transparent it is also partially reflective at least upon the front surface.

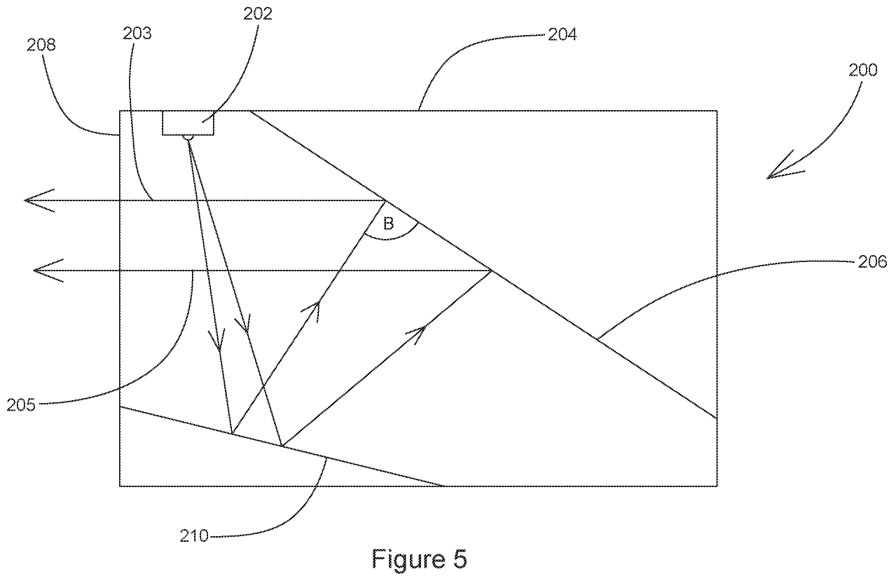

FIG. 5 is a side view of the peppers ghost projection system 200 from FIG. 4. The imaging system 200 includes projector 202, a frame 204, a partially transparent screen 206, and a reflective screen 210. The peppers ghost type imaging system 200 has a front 208. The projector 202 is shown to be located near the top of the frame 204 and projects the light downward towards the reflective screen 210. The light, arrows 203 and 205, is then reflected off of the reflective screen 210 upwardly at some angle B with the partially transparent screen 206 such that a virtual image is created from light reflected from the partially transparent screen 206. The angles of the incident light and reflected light depicted in the figures are meant to be illustrative only.

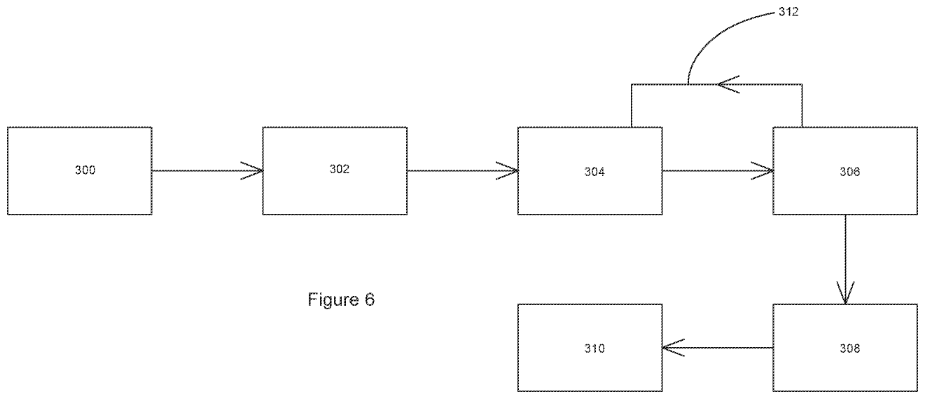

FIG. 6 is a flowchart describing the steps to provide a purchasing system utilizing a peppers ghost type imaging system. Initially, as indicated by box 300, multiple overlapping images of the particular vehicle to be presented are captured. Next, as indicated by box 302, the multiple overlapping images of the particular vehicle are compiled such that a seamless stitched image of the entire vehicle is created from the multiple overlapping images of the particular vehicle. As indicated in box 304, the images are then projected onto a pepper's ghost type imaging system such that a seemingly 3D image is created of the vehicle or the portion of the vehicle to be viewed. As indicated in box 306, a manipulation system is provided such that the viewer may use a mouse, a pointer, or even a haptic feedback system such that the viewer may move the image within the peppers ghost imaging system which, if the image is manipulated as indicated by arrow 312, the new image is then projected as indicated by box 304. As indicated in box 308, a list of the vehicle's features as well as the price may also be presented as some portion of the image within the peppers ghost type imaging system. Finally, as indicated by box 310, the salesperson may conclude the sale.

Although an embodiment of the present invention has been described herein with reference to specific exemplary apparatus, methods, techniques, or instruction sequences that embody techniques of the inventive subject matter, it will be evident that various modifications and changes may be made to these embodiments without departing from the broader spirit and scope of the invention. Accordingly, the specification and drawings are to be regarded in an illustrative rather than a restrictive sense. The accompanying figures that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of the various embodiments is defined only by the appended claims, along with the full range of equivalents to which such claims are entitled.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for selling a vehicle comprising:
providing an image of a particular vehicle,
displaying the image utilizing a peppers ghost projector,
allowing a buyer to manipulate the image, and
providing the buyer with a price for the particular vehicle.

2. The method for selling a vehicle of claim 1 wherein, the image is a photomontage of the vehicle.

3. The method for selling a vehicle of claim 1 wherein, the buyer manipulates the image utilizing a mouse.

4. The method for selling a vehicle of claim 1 wherein, the buyer manipulates the image utilizing haptic sensors.
